(19) United States
(12) Patent Application Publication
(10) Pub. No.: US 2025/0374329 A1
(43) Pub. Date: Dec. 4, 2025

(54) BASE STATION DEVICE, TERMINAL, AND RESOURCE CONTROL METHOD

(71) Applicant: SK TELECOM CO., LTD., Seoul (KR)

(72) Inventors: Sang Hoon CHO, Seoul (KR); Chi Young CHOI, Seoul (KR)

(21) Appl. No.: 18/874,462

(22) PCT Filed: Aug. 1, 2023
(86) PCT No.: PCT/KR2023/011201

§ 371 Date: Dec. 12, 2024

(30) Foreign Application Priority Data
Aug. 11, 2022 (KR) 10-2022-0100426

(51) Int. Cl. H04W 74/0833; H04W 56/00; H04W 74/08

(52) U.S. Cl. CPC H04W 74/0833; H04W 56/0045; H04W 74/0866

(57) ABSTRACT

The present disclosure relates to a method for extending cell coverage by using a subband non-overlapping full duplex (SBFD) technology in a dynamic time division duplexing environment.

### TECHNICAL FIELD

The present disclosure relates to a method for extending cell coverage according to the application of a subband non-overlapping full duplex (SBFD) technology.

This application claims priority to Korean Patent Application No. 10-2022-0100426, filed Aug. 11, 2022, whose entire disclosures are hereby incorporated by reference.

### BACKGROUND ART

In the environment of a 5G communication system environment, which has evolved from an LTE communication system, a large number of devices are connected, generating various types of data traffic.

Accordingly, data traffic, conventionally concentrated in a downlink, may diversify according to the ratio of uplink data and downlink data over time.

A dynamic time division duplexing technology is under discussion as a core technology of the 5G communication system.

The dynamic time division duplexing technology is a method of dynamically allocating time resources according to the ratio of uplink data and downlink data, unlike the existing duplexing technology of fixing resources in an environment in which the ratio of uplink data and downlink data varies as described above.

The 5G communication system may use Frequency Range 1 (FR1) including a sub-6 GHz frequency band and Frequency Range 2 (FR2) including a mmWave band (24 to 71 GHZ), thereby enabling high-speed data transmission and reducing latency.

However, despite these advantages, using a high-frequency band in the 5G communication system may rather reduce cell coverage.

Further, there is also a limitation that a large number of expensive devices are required to maintain or extend the coverage.

### DISCLOSURE OF INVENTION

### Technical Problem

The present disclosure has been designed in consideration of the above circumstances, and an aspect of the present disclosure is to extend cell coverage by utilizing a subband non-overlapping full duplex (SBFD) technology in a dynamic time division duplexing environment.

### Solution to Problem

To achieve foregoing aspect, a base station device according to an embodiment of the present disclosure includes: a memory including an instruction; and a processor configured, by executing the instruction, to discern a communication type according to a distance to a terminal, based on a timing advance (TA) value measured from a random access preamble from the terminal, and to determine a resource in a slot format that allows simultaneous allocation of an uplink resource and a downlink resource in frequency subbands according to the communication type.

Specifically, the random access preamble may be received through a specific random access channel (RACH) occasion (RO) of an RACH, and the specific RO may be configurable using two or more uplink resources allocated in a continuous section within a slot according to a format of the random access preamble.

Specifically, the processor may discern whether the communication type is a long-distance communication type from a result of comparing the TA value with a predefined threshold (Timing Advance Thresh).

Specifically, when the communication type is discerned as the long-distance communication type, the processor may determine the slot format to include two or more uplink resources allocated in a continuous section within the slot.

Specifically, the terminal may periodically discern entry into an E1 event (Event E1) regarding a change in the distance to the base station device, based on the TA value identified from the base station device according to a random access procedure for initial access, and may transmit the random access preamble to the base station device in the entry into the E1 event.

Specifically, the terminal may discern the entry into the E1 event when a result of adding or subtracting a hysteresis parameter to or from the TA value is out of a threshold range defined based on the TA value.

To achieve the foregoing aspect, a terminal according to an embodiment of the present disclosure includes: a memory including an instruction; and a processor configured, by executing the instruction, to transmit a random access preamble to a base station device according to a random access procedure for initial access, to periodically determine entry into an E1 event (Event E1) regarding a change in a distance to the base station device, based on a timing advance (TA) value when the base station device determines a resource in a slot format that allows simultaneous allocation of an uplink resource and a downlink resource in frequency subbands according to a communication type according to the distance to the base station device based on the TA value measured from the random access preamble, and to transmit the random access preamble to the base station device when determining the entry into the E1 event.

To achieve the foregoing aspect, a resource control method performed by a base station device according to an embodiment of the present disclosure includes: discerning a communication type according to a distance to a terminal, based on a timing advance (TA) value measured from a random access preamble from the terminal; and determining a resource in a slot format that allows simultaneous allocation of an uplink resource and a downlink resource in frequency subbands according to the communication type.

Specifically, the random access preamble may be received through a specific random access channel (RACH) occasion (RO) of an RACH, and the specific RO may be configurable using two or more uplink resources allocated in a continuous section within a slot according to a format of the random access preamble.

Specifically, the discerning may include discerning whether the communication type is a long-distance communication type from a result of comparing the TA value with a predefined threshold (Timing Advance Thresh).

Specifically, when the communication type is discerned as the long-distance communication type, the determining may include determining the slot format to include two or more uplink resources allocated in a continuous section within the slot.

Specifically, the terminal may periodically discern entry into an E1 event (Event E1) regarding a change in the distance to the base station device, based on the TA value identified from the base station device according to a random access procedure for initial access, and may transmit the random access preamble to the base station device in the entry into the E1 event.

Specifically, the terminal may discern the entry into the E1 event when a result of adding or subtracting a hysteresis parameter to or from the TA value is out of a threshold range defined based on the TA value.

### Advantageous Effects of Invention

According to a base station device and a resource control method of the present disclosure, it is possible to differently determine a resource pattern (TDD pattern) of a terminal 200 according to the distance to the terminal 200 in cell coverage by using the subband non-overlapping full duplex (SBFD) technology in the dynamic time division duplexing environment, thus extending cell coverage through a method of efficiently compensating for time delay occurring in long-distance communication.

### BRIEF DESCRIPTION OF DRAWINGS

FIG. 1 illustrates a slot format in a subband non-overlapping full duplex (SBFD) technology;

FIG. 2 illustrates a dynamic time division duplexing communication environment according to an embodiment of the present disclosure;

FIG. 3 illustrates the schematic configuration of a base station device according to an embodiment of the present disclosure;

FIG. 4 illustrates the configuration of an RACH occasion (RO) according to an embodiment of the present disclosure;

FIG. 5 illustrates a slot format according to an embodiment of the present disclosure;

FIG. 6 illustrates the schematic configuration of a terminal according to an embodiment of the present disclosure; and

FIG. 7 is a flowchart illustrating a resource control method according to an embodiment of the present disclosure.

### BEST MODE FOR CARRYING OUT THE INVENTION

Hereinafter, various embodiments of the present disclosure will be described with reference to the accompanying drawings.

The present disclosure relates to a subband non-overlapping full duplex (SBFD) technology.

As types of communication services and required transmission speeds in an LTE communication system are diversifying, the addition of LTE frequencies and evolution to a 5G communication system are actively in progress.

The 5G communication system supports scenarios of enhanced mobile broadband (eMBB)/massive machine-type communications (mMTC)/ultra-reliable and low-latency communications (uRLLC) while accommodating the maximum number of terminals, based on limited radio resources.

In the environment of the 5G communication system, a large number of devices are connected, generating various types of data traffic.

Accordingly, data traffic, conventionally concentrated in a downlink, may diversify according to the ratio of uplink data and downlink data over time.

A dynamic time division duplexing technology is under discussion as a core technology of the 5G communication system.

The dynamic time division duplexing technology is a method of dynamically allocating time resources according to the ratio of uplink data and downlink data, unlike the existing duplexing technology of fixing resources in an environment in which the ratio of uplink data and downlink data varies as described above.

The 5G communication system may use Frequency Range 1 (FR1) including a sub-6 GHz frequency band and Frequency Range 2 (FR2) including a mmWave band (24 to 71 GHZ), thereby enabling high-speed data transmission and reducing latency.

However, despite these advantages, using a high-frequency band in the 5G communication system may rather reduce cell coverage.

Further, there is also a limitation that a large number of expensive devices are required to maintain or extend the coverage.

In particular, cell coverage reduction occurring in urban areas and general areas may be resolved by various methods, maritime whereas coverage reduction is practically difficult to resolve due to geographical characteristics that inevitably limit device investment.

In detail, maritime coverage needs to serve a 100-km maritime area, but a slot format used in 3.5 GHZ, which is the main band of FR1, is unable to accommodate a coverage of 100 km.

To solve this problem, a slot of at least 3 ms needs to be secured to compensate for time delay that arises in during long-distance communication.

Accordingly, when a subcarrier spacing (SCS) of 30 kHz is used, six uplink (UL) resources need to be consecutively allocated to secure the slot of at least 3 ms.

However, in this case, it becomes relatively difficult to secure downlink (DL) resources, making it actually difficult to compensate for the time delay through this method.

Accordingly, an embodiment of the present disclosure proposes a new method for effectively compensating for time delay that arises in long-distance communication in the 5G communication system.

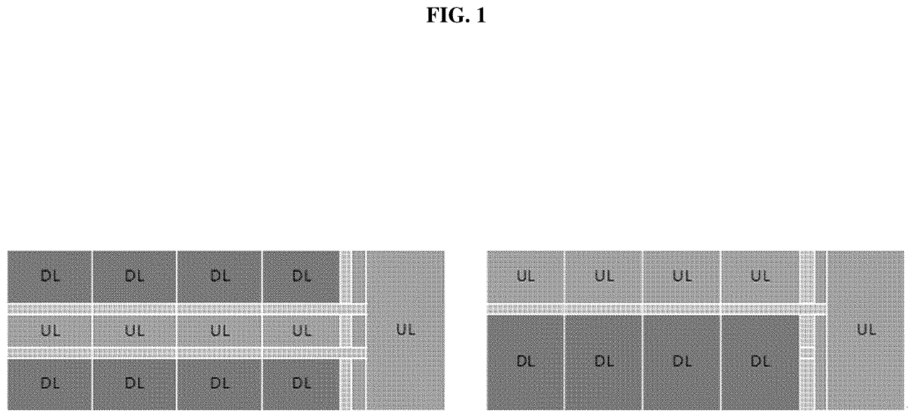

FIG. 1 illustrates a dynamic time division duplexing communication environment according to an embodiment of the present disclosure.

As illustrated in FIG. 1, the dynamic time division duplexing communication environment according to the embodiment of the present disclosure may have a configuration including a base station device 100 configured to determine a resource for a terminal 200 within cell coverage (C).

The base station device 100 may differently determine a pattern (TDD pattern) of resources allocated to the terminal 200 according to the distance to the terminal 200 within the cell coverage (C) by using a subband non-overlapping full duplex (SBFD) technology.

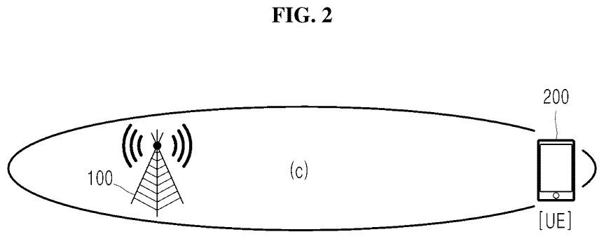

The SBFD technology is a technology under discussion in 3GPP Release 18, and may support a slot format that enables simultaneous allocation of uplink (UL) resources and downlink (DL) resources in frequency subbands, for example, as in FIG. 2, unlike an existing TDD method.

In the dynamic time division duplexing communication environment according to the embodiment of the present disclosure, it is possible to efficiently compensate for time delay occurring in long-distance communication through the foregoing configuration. Hereinafter, the configurations of the base station device 100 and the terminal 200 to realize the foregoing will be described in detail.

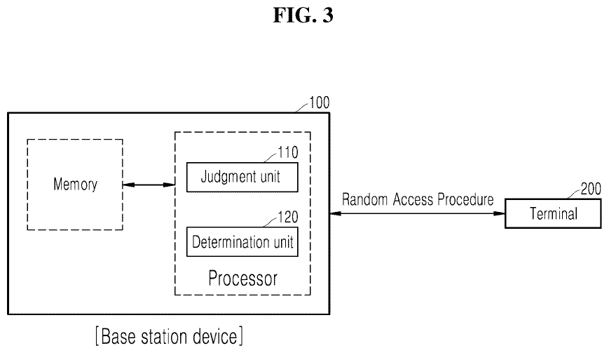

FIG. 3 schematically illustrates the configuration of a base station device 100 according to an embodiment of the present disclosure.

As illustrated in FIG. 3, the base station device 100 according to the embodiment of the present disclosure may be configured to include a memory including an instruction and a processor configured to execute the instructions in the memory.

In particular, the processor according to the embodiment of the present disclosure may have a configuration including a judgment unit 110 and a determination unit 120 depending on an implemented function according to the execution of the instruction.

The entire configuration of the base station device 100 or at least part thereof may be configured in the form of a hardware module or a software module, or may be configured in a combination of a hardware module and a software module.

The base station device 100 according to the embodiment of the present disclosure may differently determine a pattern (TDD pattern) of resources for a terminal 200 according to the distance to the terminal 200 within cell coverage (C) through the foregoing functional configuration.

Hereinafter, each functional component of the processor to realize the foregoing will be described in detail.

The judgment unit 110 performs a function of determining the communication type of the terminal 200.

Specifically, the judgment unit 110 determines the communication type according to the distance to the terminal, based on a timing advance (TA) value measured from a random access preamble of the terminal 200.

To this end, the judgment unit 110 may receive the random access preamble through a specific random access channel (RACH) occasion (OC) of an RACH.

The random access preamble may be received from the terminal 200 when the terminal 200 initially accesses a cell or when the terminal 200 enters an E1 event (Event E1) to be described below.

As the initial access of the terminal 200 to the cell according to an embodiment of the present disclosure, the initial access of the terminal 200 located at a long distance is assumed considering the same maximum cell coverage (100 km) as in an LTE communication system.

For time synchronization with the terminal 200 located at the long distance, both a delay in time for the random access preamble to reach the base station device 100 from the terminal 200 at the long distance and a delay in time for a response of the base station device 100 to the random access preamble to reach the terminal 200 need to be considered.

Therefore, to measure a long time delay corresponding to the size of the maximum cell coverage (100 km), it is necessary to secure consecutive uplink (UL) resources of at least 3 ms.

For reference, this case assumes a situation where six uplink (UL) resources needs to be allocated in a continuous section to secure a slot of at least 3 ms when using a subcarrier spacing (SCS) of 30 kHz in a 3.5 GHZ band.

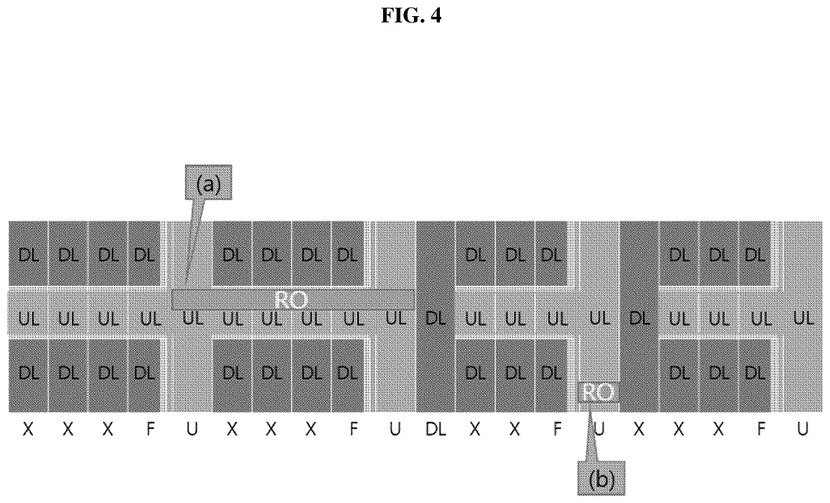

Accordingly, in an embodiment of the present disclosure, when the terminal 200 initially accesses a remote cell, a specific RACH occasion (RO) of a random access channel (RACH) selected to transmit a random access preamble may be configured with six uplink resources allocated in a continuous section within a slot, for example, as in FIG. 4A.

The RACH occasion configured with the six uplink resources allocated in the continuous section within the slot may be configured by a random access preamble format (Preamble Format=1) that enables the largest cell coverage to be secured according to a standard of the 5G communication system.

In summary, when the terminal 200 initially accesses the remote cell, the specific RACH occasion (RO) for transmitting the random access preamble may be configured using the six uplink resources allocated in the continuous section within the slot through the random access preamble format (Preamble Format=1) in order to secure the largest cell coverage.

For reference, although the embodiment of the present disclosure shows that the six uplink resources allocated in the continuous section are used for configuring the RACH occasion (RO), there is no particular limitation on the number of uplink resources, and the number may be configured to any number greater than or equal to 2 according to a configuration by an operator considering the size of cell coverage.

In an embodiment of the present disclosure, the the terminal 200 is also short-distance access of considered, in which case the specific RACH occasion (RO) of the random access channel (RACH) may be configured with a single uplink resource by default, for example, as in FIG. 4B.

For reference, considering a case of using the subcarrier spacing (SCS) of 30 kHz in the 3.5 GHz band, the single uplink resource may support the measurement of a time delay corresponding to a maximum cell coverage of 4.6 km.

When receiving the random access preamble through the specific RACH occasion (RO) of the random access channel (RACH), the judgment unit 110 determines the communication type according to the distance to the terminal 200, based on the timing advance (TA) value (Nₜₐ_Offset) measured from the received random access preamble.

The judgment unit 110 may determine whether the communication type according to the distance to the terminal 200 corresponds to a long-distance communication type by using the result of comparing the TA value (Nₜₐ_Offset) with a predefined threshold (Timing Advance Thresh).

That is, as a result of comparing the TA value (Nₜₐ_Offset) with the predefined threshold (Timing Advance Thresh), when the TA value (Nₜₐ_Offset) is equal to or greater than the predefined threshold (Timing Advance Thresh), the judgment unit 110 may determine that the communication type is the long-distance communication type in which the distance to the terminal 200 is long, and when the TA value (Nₜₐ_Offset) is less than predefined threshold (Timing Advance Thresh), the judgment unit 110 may determine that the communication type is a short-distance communication type in which the distance to the terminal 200 is relatively short.

For reference, the threshold (Timing Advance Thresh) is a value configured by the operator according to TS38.133, and may be configured to range, for example, from 0 to 25600.

The determination unit 120 performs a function of determining a resource for the terminal 200 according to the determined communication type.

Specifically, when the communication type according to the distance to the terminal 200 is determined, the determination unit 120 differently determines a resource pattern (TDD pattern) of the terminal 200 according to the determined communication type.

When the communication type is determined as the long-distance communication type, the determination unit 120 may determine an uplink slot format (UL coverage slot format) in which uplink resources are allocated in a continuous section within a slot for the terminal 200.

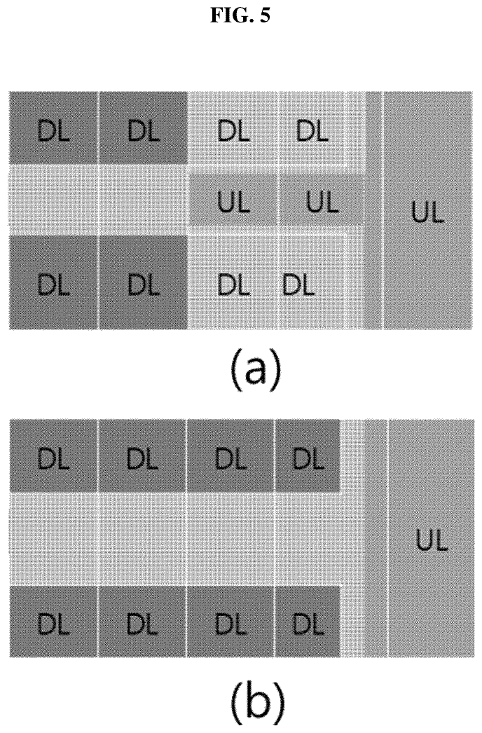

Accordingly, the determination 120 may unit determine an uplink slot format including at least two uplink resources in a continuous section, for example, as in FIG. 5A, in view of the long-distance communication type.

When the communication type is determined as the short-distance communication type, the determination unit 120 may determine a default slot format for the terminal 200.

The default slot format may have a format, for example, as in FIG. 5B. In particular, the default slot format may be determined based on a TDD-UL-DL-ConfigDedicated parameter, which is an RRC IE used when configuring TDD for a specific terminal (UE specific) in 3GPP TS38.331 below.

TDD-UL-DL-ConfigCommon information element
-- ASN1START
-- TAG-TDD-UL-DL-CONFIGCOMMON-START

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD UL DL |
| Pattern | OPTIONAL, -- Need R |

...
}

| | |
|---|---|
| TDD-UL-DL-Pattern ::= | SEQUENCE{ |
| dl-UL-TransmissionPeriodicity | ENUMERATED (ms0p5, ms0p625, |

ms1, ms1p25, ms2, ms2p5, ms5, ms10},

| | |
|---|---|
| nrofDownlinkSlots | INTEGER (0..maxNrofSlots), |
| nrofDownlinkSymbols | INTEGER (0..maxNrofSymbols-1), |
| nrofUplinkSlots | INTEGER (0..maxNrofSlots), |
| nrofUplinkSymbols | INTEGER (0..maxNrofSymbols-1), |

```
  ...,
  [[
  dl-UL-TransmissionPeriodicity-v1530 ENUMERATED {ms3,
```

| | |
|---|---|
| ms4] | OPTIONAL -- Need R |

]]
}
-- TAG-TDD-UL-DL-CONFIGCOMMON-STOP
-- ASN1START

For reference, information about a slot format determined as the uplink slot format (UL coverage slot format) or the default slot format according to the communication type is transmitted along with the TA value (Nₜₐ_Offset) to the terminal 200 through random access response reception (MSG2), which is a response to random access preamble transmission (MSG1) in which the random access preamble is received from the terminal 200, and a random access procedure may be completed via the following scheduled transmission (MSG3), contention resolution (MSG4), and completion the of random access procedure (MSG5).

When the random access procedure is completed, the terminal 200 periodically determines whether the terminal 200 enters the E1 event (Event E1) regarding a change in the distance from the base station device 100, based on the TA value (Nₜₐ_Offset) received from the base station device 100, and when determining that the terminal 200 enters the E1 event, the terminal 200 transmits a random access preamble to the base station device 100 so that the base station device 100 may re-determine a slot format according to the change in the distance.

Here, the terminal 200 may determine that the terminal 200 enters the E1 event when the result of adding or subtracting a hysteresis parameter to or from the TA value (Nₜₐ_Offset) exceeds the range of a threshold defined based on the TA value (Nₜₐ_Offset).

A specific conditional expression for determining entry into the E1 event may be defined as follows.

Event E1
The UE shall:

| | |
|---|---|
| 1> | consider the entering condition for this event to be satisfied when both condition E1, as specified |
| | below, is fulfilled; |

Inequality E1-1 (Entering condition)
Ml1 − Hys > Thresh1
Inequality D1-2 (Leaving condition)
Ml1 + Hys < Thresh1
The variables in the formula are defined as follows:
Ml1 is the UE TA value, represented by the Timing Advance parameter for this event, not taking

into account any offsets.

Hys is the hysteresis parameter for this event (i.e. hysteresis as defined within reportConfigNR for

this event).

Thresh1 is the threshold for this event defined as a TA, configured with parameter N_{TA}_{_{—}}offset, from

a reference location configured with parameter N_{TA}_{_{—}}offset within reportConfigNR for this event.

```
    Ml1 is expressed in Fixed timing advance offset.
    Hys is expressed in the same unit as Ml1.
    Thresh is expressed in the same unit as MIT.
```

The random access preamble transmitted when determining that the terminal 200 enters the E1 event may be transmitted based on a communication type determined in the previous random access procedure, and may be transmitted to the base station device 100 through an RACH occasion (RO) configured with consecutive uplink resources in a slot as illustrated above in FIG. 4A in long-distance communication, and to the base station device 100 through an RACH occasion (RO) configured with a single uplink resource as illustrated above in FIG. 4B in short-distance communication.

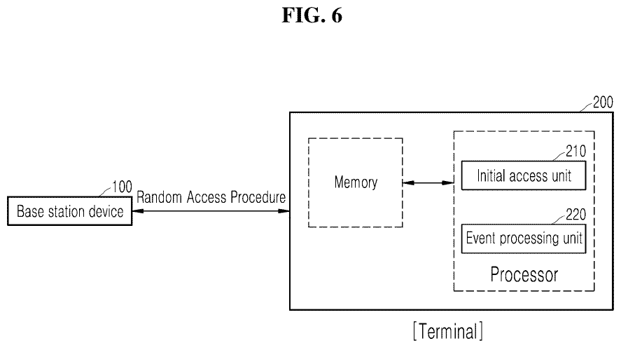

FIG. 6 schematically illustrates the configuration of a terminal 200 according to an embodiment of the present disclosure.

As illustrated in FIG. 6, the terminal 200 according to the embodiment of the present disclosure may be configured to include a memory including an instruction and a processor configured to execute the instructions in the memory.

In particular, the processor according to the embodiment of the present disclosure may have an initial access unit 210 and an event processing unit 220 depending on an implemented function according to the execution of the instruction.

The entire configuration of the terminal 200 or at least part thereof may be configured in the form of a hardware module or a software module, or may be configured in a combination of a hardware module and a software module.

The terminal 200 according to the embodiment of the present disclosure may support differently determining a pattern (TDD pattern) of resources for the terminal 200 according to the distance to a base station device 100 within cell coverage (C) through the foregoing functional configuration.

Hereinafter, each functional component of the processor to realize the foregoing will be described in detail.

The initial access unit 210 is responsible for a function of processing a random accessor for initial access.

Specifically, the initial access unit 210 transmits a random access preamble to the base station device according to a random access procedure for the initial access, so that resources in a slot format that allows simultaneous allocation of uplink resources and downlink resources in frequency subbands is determined according to a communication type according to the distance to the base station device based on a timing advance (TA) value measured from the random access preamble.

The random access preamble may be received from the terminal 200 when initially accessing a cell or entering an E1 event (Event E1) to be described below.

As the initial access to the cell according to an embodiment of the present disclosure, the initial access of the terminal 200 located at a long distance is assumed considering the same maximum cell coverage (100 km) as in an LTE communication system.

For time synchronization with the terminal 200 located at the long distance, both a delay in time for the random access preamble to reach the base station device 100 from the terminal 200 at the long distance and a delay in time for a response of the base station device 100 to the random access preamble to reach the terminal 200 need to be considered.

Therefore, to measure a long time delay corresponding to the size of the maximum cell coverage (100 km), it is necessary to secure consecutive uplink (UL) resources of at least 3 ms.

For reference, this case assumes a situation where six uplink (UL) resources needs to be allocated in a continuous section to secure a slot of at least 3 ms when using a subcarrier spacing (SCS) of 30 kHz in a 3.5 GHZ band.

Accordingly, in an embodiment of the present disclosure, in initial access to a remote cell, a specific RACH occasion (RO) of a random access channel (RACH) selected to transmit a random access preamble may be configured with six uplink resources allocated in a continuous section within a slot as illustrated above in FIG. 4A.

The RACH occasion (RO) configured with the six uplink resources allocated in the continuous section within the slot may be configured by a random access preamble format (Preamble Format=1) that enables the largest cell coverage to be secured according to a standard of the 5G communication system.

In summary, in the initial access to the remote cell, the specific RACH occasion (RO) for transmitting the random access preamble may be configured using the six uplink resources allocated in the continuous section within the slot through the random access preamble format (Preamble Format=1) in order to secure the largest cell coverage.

For reference, although the embodiment of the present disclosure shows that the six uplink resources allocated in the continuous section are used for configuring the RACH occasion (RO), there is no particular limitation on the number of uplink resources, and the number may be configured to any number greater than or equal to 2 according to a configuration by an operator considering the size of cell coverage.

In an embodiment of the present disclosure, the short-distance access of the terminal 200 is also considered, in which case the specific RACH occasion (RO) of the random access channel (RACH) may be configured with a single uplink resource by default as illustrated in FIG. 4B.

For reference, considering a case of using the subcarrier spacing (SCS) of 30 kHz in the 3.5 GHz band, the single uplink resource may support the measurement of a time delay corresponding to a maximum cell coverage of 4.6 km.

When receiving the random access preamble through the specific RACH occasion (RO) of the random access channel (RACH), the base station device 100 determines the communication type according to the distance to the terminal 200, based on the timing advance (TA) value (Nₜₐ_Offset) measured from the received random access preamble.

The base station device 100 may determine whether the communication type according to the distance to the terminal 200 corresponds to a long-distance communication type by using the result of comparing the TA value (Nₜₐ_Offset) with a predefined threshold (Timing Advance Thresh).

That is, as a result of comparing the TA value (Nₜₐ_Offset) with the predefined threshold (Timing Advance Thresh), when the TA value (Nₜₐ_Offset) is equal to or greater than the predefined threshold (Timing Advance Thresh), the base station device 100 may determine that the communication type is the long-distance communication type in which the distance to the terminal 200 is long, and when the TA value (Nₜₐ_Offset) is less than predefined threshold (Timing Advance Thresh), the base station device 100 may determine that the communication type is a short-distance communication type in which the distance to the terminal 200 is relatively short.

For reference, the threshold (Timing Advance Thresh) is a value configured by the operator according to TS38.133, and may be configured to range, for example, from 0 to 25600.

When the communication type according to the distance to the terminal 200 is determined, the base station device 100 differently determines resource pattern (TDD pattern) of the terminal 200 according to the determined communication type.

When the communication type is determined as the long-distance communication type, the base station device 100 may determine an uplink slot format (UL coverage slot format) in which uplink resources are allocated in a continuous section within a slot for the terminal 200.

Accordingly, the base station device 100 may determine an uplink slot format including at least two uplink resources in a continuous section, as illustrated above in FIG. 5A, in view of the long-distance communication type.

When the communication type is determined as the short-distance communication type, the base station device 100 may determine a default slot format for the terminal 200.

The default slot format may have a format as illustrated in FIG. 5B. In particular, the default slot format may be determined based on a TDD-UL-DL-ConfigDedicated parameter, which is an RRC IE used when configuring TDD for a specific terminal (UE specific) in 3GPP TS38.331 below.

For reference, information about a slot format determined as the uplink slot format (UL coverage slot format) or the default slot format according to the communication type is transmitted along with the TA value (Nₜₐ_Offset) to the terminal 200 through random access response reception (MSG2), which is a response to random access preamble transmission (MSG1) in which the random access preamble is received from the terminal 200, and a random access procedure may be completed via the following scheduled transmission (MSG3), contention resolution (MSG4), and completion of the random access procedure (MSG5).

The event processing unit 220 is responsible for a function of processing the E1 event.

Specifically, when the random access procedure for the initial access is completed, the event processing unit 220 periodically determines whether the terminal 200 enters the E1 event (Event E1) regarding a change in the distance from the base station device 100, based on the TA value (Nₜₐ_Offset) received from the base station device 100, and when determining the entry into the E1 event, the event processing unit 220 transmits a random access preamble to the base station device 100 so that the base station device 100 may re-determine a slot format according to the change in the distance.

Here, the event processing unit 220 may determine that the terminal 200 enters the E1 event when the result of adding or subtracting a hysteresis parameter to or from the TA value (Nₜₐ_Offset) exceeds the range of a threshold defined based on the TA value (Nₜₐ_Offset).

The random access preamble transmitted when determining the entry into the E1 event may be transmitted based on a communication type determined in the previous random access procedure, and may be transmitted to the base station device 100 through an RACH occasion (RO) configured with consecutive uplink resources in a slot as illustrated above in FIG. 4A in long-distance communication, and to the base station device 100 through an RACH occasion (RO) configured with a single uplink resource as illustrated above in FIG. 4B in short-distance communication.

As described above, according to the configurations of the base station device 100 and the terminal 200 according to the embodiments of the present disclosure, it is possible to differently determine a resource pattern (TDD pattern) of the terminal 200 according to the distance to the terminal 200 in cell coverage by using the subband non-overlapping full duplex (SBFD) technology in the dynamic time division duplexing environment, thus extending cell coverage through a method of efficiently compensating for time delay occurring in long-distance communication.

Further, according to the configurations of the base station device 100 and the terminal 200 according to the embodiments of the present disclosure, utilizing the subband non-overlapping full duplex (SBFD) technology to extend cell coverage enables a specific terminal 200 among terminals 200 using half-duplex to transmit a downlink and a specific terminal to transmit uplink at the same time, making it possible to install a minimal number of base stations by resolving a lack in uplink resources depending on purposes, to simultaneously allocate downlink resources and uplink resources in frequency subbands to reduce latency and thus improve service quality, and to improve quality particularly in real-time voice IP service, which is poor in TDD.

In addition, according to the configurations of the base station device 100 and the terminal 200 according to the embodiments of the present disclosure, since a standard of the E1 event, which is a distance-based event, is applied, an effect of facilitating the identification of the distance to the terminal may also be expected in comparison with RSRP, RSRQ, and RSSI events based on signal strength.

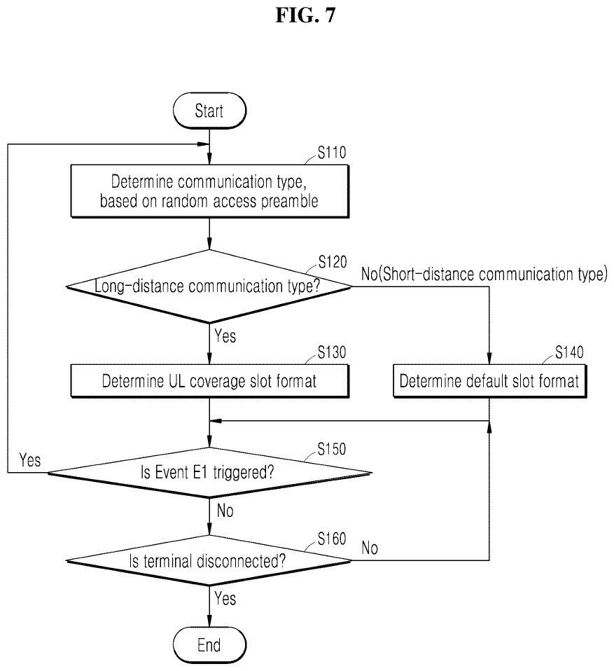

Hereinafter, a resource control method according to an embodiment of the present disclosure will be described with reference to FIG. 7.

For convenience of explanation, in the following description, the base station device 100 and the terminal 200 described with reference to FIG. 3 will be referred to as an entity to perform the resource control method.

First, the base station device 100 determines a communication type according to the distance to the terminal, based on a timing advance (TA) value measured from a random access preamble of the terminal 200 (S110).

To this end, the base station device 100 receives the random access preamble through a specific random access channel (RACH) occasion (OC) of an RACH.

The random access preamble may be received from the terminal 200 when the terminal 200 initially accesses a cell or when the terminal 200 enters an E1 event (Event E1) to be described below.

As the initial access of the terminal 200 to the cell according to an embodiment of the present disclosure, the initial access of the terminal 200 located at a long distance is assumed considering the same maximum cell coverage (100 km) as in an LTE communication system.

For time synchronization with the terminal 200 located at the long distance, both a delay in time for the random access preamble to reach the base station device 100 from the terminal 200 at the long distance and a delay in time for a response of the base station device 100 to the random access preamble to reach the terminal 200 need to be considered.

Therefore, to measure a long time delay corresponding to the size of the maximum cell coverage (100 km), it is necessary to secure consecutive uplink (UL) resources of at least 3 ms.

For reference, this case assumes a situation where six uplink (UL) resources needs to be allocated in a continuous section to secure a slot of at least 3 ms when using a subcarrier spacing (SCS) of 30 kHz in a 3.5 GHZ band.

Accordingly, in an embodiment of the present disclosure, when the terminal 200 initially accesses a remote cell, a specific RACH occasion (RO) of a random access channel (RACH) selected to transmit a random access preamble may be configured with six uplink resources allocated in a continuous section within a slot as illustrated in FIG. 4A.

The RACH occasion (RO) configured with the six uplink resources allocated in the continuous section within the slot may be configured by a random access preamble format (Preamble Format=1) that enables the largest cell coverage to be secured according to a standard of the 5G communication system.

In summary, when the terminal 200 initially accesses the remote cell, the specific RACH occasion (RO) for transmitting the random access preamble may be configured using the six uplink resources allocated in the continuous section within the slot through the random access preamble format (Preamble Format=1) in order to secure the largest cell coverage.

For reference, although the embodiment of the present disclosure shows that the six uplink resources allocated in the continuous section are used for configuring the RACH occasion (RO), there is no particular limitation on the number of uplink resources, and the number may be configured to any number greater than or equal to 2 according to a configuration by an operator considering the size of cell coverage.

In an embodiment of the present disclosure, the short-distance access of the terminal 200 is also considered, in which case the specific RACH occasion (RO) of the random access channel (RACH) may be configured with a single uplink resource by default as illustrated in FIG. 4B.

For reference, considering a case of using the subcarrier spacing (SCS) of 30 kHz in the 3.5 GHz band, the single uplink resource may support the measurement of a time delay corresponding to a maximum cell coverage of 4.6 km.

When receiving the random access preamble through the specific RACH occasion (RO) of the random access channel (RACH), the base station device 100 determines the communication type according to the distance to the terminal 200, based on the timing advance (TA) value (Nₜₐ_Offset) measured from the received random access preamble.

The base station device 100 may determine whether the communication type according to the distance to the terminal 200 corresponds to a long-distance communication type by using the result of comparing the TA value (Nₜₐ_Offset) with a predefined threshold (Timing Advance Thresh).

That is, as a result of comparing the TA value (Nₜₐ_Offset) with the predefined threshold (Timing Advance Thresh), when the TA value (Nₜₐ_Offset) is equal to or greater than the predefined threshold (Timing Advance Thresh), the base station device 100 may determine that the communication type is the long-distance communication type in which the distance to the terminal 200 is long, and when the TA value (Nₜₐ_Offset) is less than predefined threshold (Timing Advance Thresh), the base station device 100 may determine that the communication type is a short-distance communication type in which the distance to the terminal 200 is relatively short.

For reference, the threshold (Timing Advance Thresh) is a value configured by the operator according to TS38.133, and may be configured to range, for example, from 0 to 25600.

When the communication type according to the distance to the terminal 200 is determined, the base station device 100 differently determines a resource pattern (TDD pattern) of the terminal 200 according to the determined communication type (S120 to S140).

When the communication type is determined as the long-distance communication type, the base station device 100 may determine an uplink slot format (UL coverage slot format) in which uplink resources are allocated in a continuous section within a slot for the terminal 200.

Accordingly, the base station device 100 may determine an uplink slot format including at least two uplink resources in a continuous section, for example, as in FIG. 5A, in view of the long-distance communication type.

When the communication type is determined as the short-distance communication type, the base station device 100 may determine a default slot format for the terminal 200.

The default slot format may have a format as illustrated in FIG. 5B. In particular, the default slot format may be determined based on a TDD-UL-DL-ConfigDedicated parameter, which is an RRC IE used when configuring TDD for a specific terminal (UE specific) in 3GPP TS38.331.

For reference, information about a slot format determined as the uplink slot format (UL coverage slot format) or the default slot format according to the communication type is transmitted along with the TA value (Nₜₐ_Offset) to the terminal 200 through random access response reception (MSG2), which is a response to random access preamble transmission (MSG1) in which the random access preamble is received from the terminal 200, and a random access procedure may be completed via the following scheduled transmission (MSG3), contention resolution (MSG4), and completion of the random access procedure (MSG5).

Subsequently, when the random access procedure is completed, the terminal 200 periodically determines whether the terminal 200 enters the E1 event (Event E1) regarding a change in the distance from the base station device 100, based on the TA value (Nₜₐ_Offset) received from the base station device 100, and when determining that the terminal 200 enters the E1 event, the terminal 200 transmits a random access preamble to the base station device 100 so that the base station device 100 may re-determine a slot format according to the change in the distance (S150).

Here, the terminal may determine that the terminal 200 enters the E1 event when the result of adding or subtracting a hysteresis parameter to or from the TA value (Nₜₐ_Offset) exceeds the range of a threshold defined based on the TA value (Nₜₐ_Offset).

The random access preamble transmitted when determining that the terminal 200 enters the E1 event may be transmitted based on a communication type determined in the previous random access procedure, and may be transmitted to the base station device 100 through an RACH occasion (RO) configured with consecutive uplink resources in a slot as illustrated above in FIG. 4A in long-distance communication, and to the base station device 100 through an RACH occasion (RO) configured with a single uplink resource as illustrated above in FIG. 4B in short-distance communication.

The foregoing process corresponding to operations S110 to S150 is repeated until the terminal 200 is disconnected from the base station device 100 (S160).

As described above, according to the resource control method according to the embodiment of the present disclosure, it is possible to differently determine a resource pattern (TDD pattern) of the terminal 200 according to the distance to the terminal 200 in cell coverage by using the subband non-overlapping full duplex (SBFD) technology in the dynamic time division duplexing environment, thus extending cell coverage through a method of efficiently compensating for time delay occurring in long-distance communication.

Further, according to the resource control method according to the embodiment of the present disclosure, utilizing the subband non-overlapping full duplex (SBFD) technology to extend cell coverage enables a specific terminal 200 among terminals 200 using half-duplex to transmit a downlink and a specific terminal to transmit uplink at the same time, making it possible to install a minimal number of base stations by resolving a lack in uplink resources depending on purposes, to simultaneously allocate downlink resources and uplink resources in frequency to reduce latency and thus improve service quality, and to improve quality particularly in real-time voice IP service, which is poor in TDD.

In addition, according to the resource control method according to the embodiment of the present disclosure, since a standard of the E1 event, which is a distance-based event, is applied, an effect of facilitating the identification of the distance to the terminal may also be expected in comparison with RSRP, RSRQ, and RSSI events based on signal strength.

The resource control method according to an embodiment of the present disclosure may be implemented in a form of program command that may be configured to be executed through various computer means and recorded on a computer readable medium. The computer readable medium may include program commands, data files, data structures, etc. alone or in combination. Program commands recorded on the medium may be specially designed and configured for the present disclosure or known and usable to those skilled in computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program commands, such as ROM, RAM, flash memory, and the like. Examples of program commands include high-level language codes that may be executed by a computer using an interpreter, as well as machine language codes produced by a compiler. The aforementioned hardware device may be configured to function as one or more software modules to perform the operations of the present disclosure, and vice versa.

Although the present disclosure has been described in detail with reference to preferred embodiments, the present disclosure is not limited to the above-described embodiments, and the technical idea of the present disclosure extends to the extent that any person with ordinary knowledge in the technical field to which the present disclosure belongs may make various changes or modifications without departing from the gist of the present disclosure claimed in the following claims.

1. A base station device comprising:
a memory comprising an instruction; and
a processor configured to, by executing the instruction, discern a communication type according to a distance to a terminal, based on a timing advance (TA) value measured from a random access preamble from the terminal, and determine a resource in a slot format that allows simultaneous allocation of an uplink resource and a downlink resource in frequency subbands according to the communication type.

2. The base station device of claim 1, wherein the random access preamble is received through a specific random access channel (RACH) occasion (RO) of an RACH, and
wherein the specific RO is configurable using two or more uplink resources allocated in a continuous section within a slot, according to a format of the random access preamble.

3. The base station device of claim 1, wherein the processor is configured to discern whether the communication type is a long-distance communication type from a result of comparing the TA value with a predefined threshold (Timing Advance Thresh).

4. The base station device of claim 1, wherein the processor is configured to, when the communication type is discerned as the long-distance communication type, determine the slot format to comprise two or more uplink resources allocated in a continuous section within the slot.

5. The base station device of claim 1, wherein the terminal is configured to periodically discern entry into an E1 event (Event E1) regarding a change in the distance to the base station device, based on the TA value identified from the base station device, according to a random access procedure for initial access, and transmit the random access preamble to the base station device in the entry into the E1 event.

6. The base station device of claim 5, wherein the terminal is configured to discern the entry into the E1 event when a result of adding or subtracting a hysteresis parameter to or from the TA value is out of a threshold range defined based on the TA value.

7. A terminal comprising:
a memory comprising an instruction; and
a processor configured to, by executing the instruction, transmit a random access preamble to a base station device according to a random access procedure for initial access, periodically determine entry into an E1 event (Event E1) regarding a change in a distance to the base station device, based on a timing advance (TA) value when the base station device determines a resource in a slot format that allows simultaneous allocation of an uplink resource and a downlink resource in frequency subbands according to a communication type according to the distance to the base station device, based on the TA value measured from the random access preamble, and transmit the random access preamble to the base station device when determining the entry into the E1 event.

8. A resource control method performed by a base station device, the resource control method comprising:
discerning a communication type according to a distance to a terminal, based on a timing advance (TA) value measured from a random access preamble from the terminal; and
determining a resource in a slot format that allows simultaneous allocation of an uplink resource and a downlink resource in frequency subbands according to the communication type.

9. The resource control method of claim 8, wherein the random access preamble is received through a specific random access channel (RACH) occasion (RO) of an RACH, and
wherein the specific RO is configurable using two or more uplink resources allocated in a continuous section within a slot, according to a format of the random access preamble.

10. The resource control method of claim 8, wherein the discerning comprises discerning whether the communication type is a long-distance communication type from a result of comparing the TA value with a predefined threshold (Timing Advance Thresh).

11. The resource control method of claim 8, wherein, when the communication type is discerned as the long-distance communication type, the determining comprises determining the slot format to comprise two or more uplink resources allocated in a continuous section within the slot.

12. The resource control method of claim 8, wherein the terminal periodically discerns entry into an E1 event (Event E1) regarding a change in the distance to the base station device, based on the TA value identified from the base station device, according to a random access procedure for initial access, and transmits the random access preamble to the base station device in the entry into the E1 event.

13. The resource control method of claim 12, wherein the terminal discerns the entry into the E1 event when a result of adding or subtracting a hysteresis parameter to or from the TA value is out of a threshold range defined based on the TA value.

14. A computer-readable recording medium recording a program to execute the method of claim 8.

15. A computer program stored in a medium to execute the method of claim 8 in combination with hardware.
